(19) United States
(12) Patent Application Publication
(10) Pub. No.: US 2009/0231364 A1
(43) Pub. Date: Sep. 17, 2009

(54) DISPLAY SYSTEM CAPABLE OF AUTO-REGULATING BRIGHTNESS AND BRIGHTNESS AUTO-REGULATING METHOD THEREOF

(75) Inventor: CHUNG-CHIH TSAI, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/136,779

(22) Filed: Jun. 11, 2008

(30) Foreign Application Priority Data
Mar. 14, 2008 (CN) 200810300573.0

(51) Int. Cl. G09G 5/10

(52) U.S. Cl. 345/690

(57) ABSTRACT

A display system includes a display panel, an imaging unit, an auto-focusing controller, a calculating unit, a memory unit and a regulating unit. The imaging unit is configured for capturing images. The auto-focusing controller is configured for determining parameters of the imaging unit suitable for the current ambient light condition by processing the captured images. The calculating unit is configured for calculating a brightness value of the current ambient light condition, using the determined parameters. The memory unit is configured for storing an array comprising a collection of brightness values associated with a collection of driving voltage values respectively. The regulating unit is configured for retrieving a driving voltage value in an array associated with the calculated brightness value, and adjusting the display panel using the retrieved voltage value.

### BACKGROUND

1. Technical Field

The present invention relates to display systems and, particularly, to a display system capable of auto-regulating brightness and a brightness auto-regulating method thereof.

2. Description of the Related Art

Displays are used in various devices, such as cameras, cellular phones, and laptop computers. These displays may be used in various ambient light conditions. Different ambient light conditions require a different level of brightness of displays for comfortable viewing. Unfortunately, most display devices require manual adjustments to the brightness level, which can be inconvenient.

### SUMMARY

A display system includes a display panel, an imaging unit, an auto-focusing controller, a calculating unit, a memory unit and a regulating unit. The imaging unit is configured for capturing images. The auto-focusing controller is configured for determining parameters of the imaging unit suitable for the current ambient light condition by processing the captured images. The calculating unit is configured for calculating a brightness value of the current ambient light condition, using the determined parameters. The memory unit is configured for storing an array comprising a collection of brightness values associated with a collection of driving voltage values respectively. The regulating unit is configured for retrieving a driving voltage value in an array associated with the calculated brightness value, and adjusting the display panel using the retrieved voltage value.

Other advantages and novel features will be drawn from the following detailed description of exemplary embodiments, when considered in conjunction with the attached drawings.

### BRIEF DESCRIPTION OF THE DRAWINGS

Many aspects of the present display system and method can be better understood with reference to the accompanying drawings. The components in the drawings are not necessarily drawn to scale, the emphasis instead being placed upon clearly illustrating the principles of the present display system and method. Moreover, in the drawings, like reference numerals designate corresponding parts throughout the several views.

FIG. 1 shows a functional block diagram of a display system in accordance with an exemplary embodiment.

FIG. 2 is a flowchart of a method for auto-regulating brightness of a display panel in accordance with another embodiment.

### DETAILED DESCRIPTION OF THE EMBODIMENTS

Embodiments of the present display system and method will now be described in detail below with reference to the drawings.

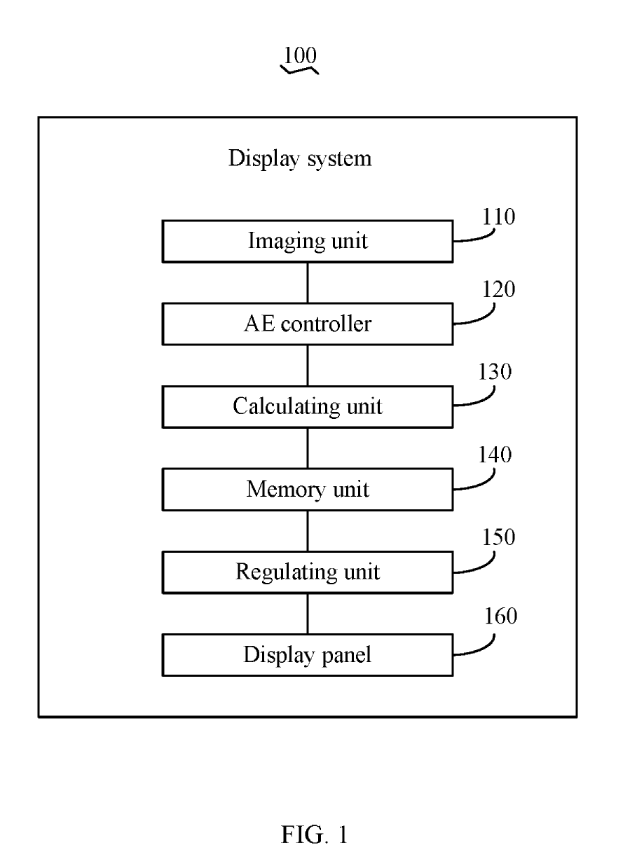

Referring to FIG. 1, a display system 100 in accordance with an exemplary embodiment includes an imaging unit 110, an auto-exposure (AE) controller 120, a calculating unit 130, a memory unit 140, a regulating unit 150, and a display panel 160. The imaging unit 110 is configured for capturing images. The AE controller 120 is configured for processing the captured images to determine parameters of the imaging unit suitable for the current ambient light conditions. The calculating unit 130 is configured for calculating a brightness value of the current ambient light conditions using the determined parameters. The memory unit 140 is configured for storing an array including a collection of brightness values respectively associated with a collection of driving voltage values. The regulating unit 150 is configured for retrieving a driving voltage value associated with the calculated brightness value in the array, and adjusting the display panel using the retrieved voltage value.

The imaging unit 110 is configured for capturing images. The imaging unit 110 can be, for example, a video camera, and includes an exposure section and an image sensor. The exposure section is configured for regularly exposing the image sensor. Specifically, the exposure section includes a fixed diaphragm with a fixed aperture value Fv, or an iris diaphragm with variable aperture values Fv controllable by the AE unit 120. The exposure section exposes the image sensor for an exposure time (shutter speed) Tv in seconds. The image sensor can be exposed using a fixed speed value (ISO speed) Sv, or different Sv values controlled by the AE unit 120.

The AE controller 120 is configured for determining parameters suitable for a current ambient light condition by processing the captured images. The parameters comprise, for example, Fv, Tv, and Sv and an exposure value Ev determined by the AE controller 120.

The calculating unit 130 is configured for calculating a brightness value Bv of the current ambient light condition, based on the parameters of the imaging unit 110. For example, the Ev, Tv, Fv, and Bv of the imaging unit 10 satisfy an equation:

Ev=log₂(0.3Sv)+log₂(Bv/K)=2 log₂(Fv)+log₂(1/Tv),

where K is a constant experiential coefficient of the image field. As a result, the brightness value Bv can be obtained, since Sv, Fv, Tv, and K are already known.

The memory unit 140 is configured for storing an array including a collection of brightness values Bv associated with a collection of driving voltage values respectively. In this embodiment, in order to simplify the algorithms used for lookup in the array, the brightness values Bv in the array are integers, and the calculated brightness value Bv is rounded to the nearest integer by the calculating unit 130.

The regulating unit 150 is configured for retrieving a driving voltage value associated with the calculated brightness value Bv in the array, and adjusting the brightness of the display panel 160 using the retrieved voltage value. As a result, the brightness of the display panel 160 is harmonized with the brightness of the current ambient light condition.

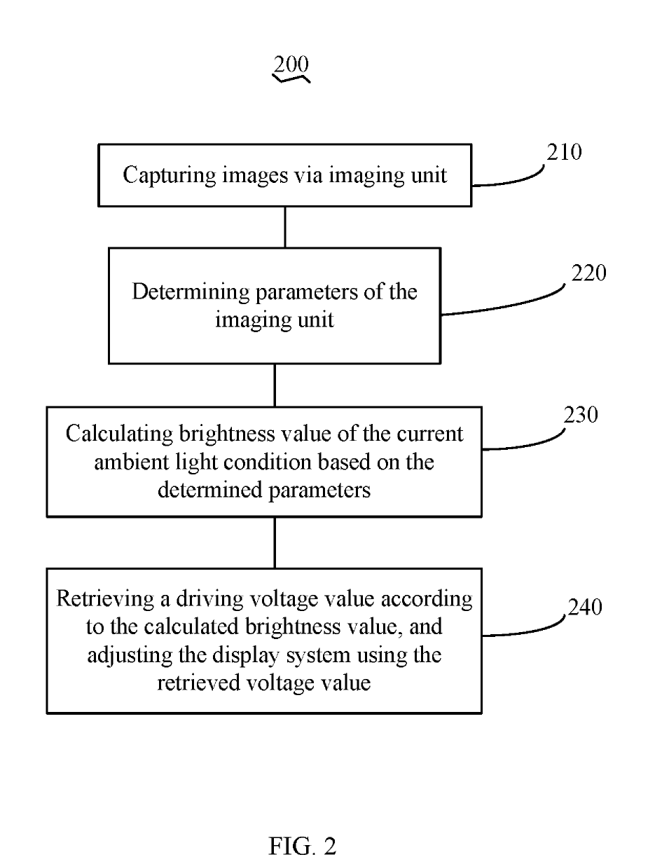

Referring to FIG. 2, a method 200 for auto-regulating the brightness of a display system in accordance with an exemplary embodiment comprises steps 210 through 240. Step 210: capturing images via an imaging unit. Step 220: determining parameters of the imaging unit that are suitable for the current ambient light condition by processing the images. Step 230: calculating a brightness value Bv of the current ambient light condition using the determined parameters. Step 240: retrieving a driving voltage value in an array associated with the calculated brightness value Bv, and adjusting the display system using the retrieved voltage value.

Specifically, the parameters of the imaging unit comprises, for example, exposure value Ev, aperture value Fv, exposure time Tv, and ISO speed Sv. The exposure value Ev, aperture value Fv, exposure time Tv, ISO speed Sv and brightness value Bv satisfy the following equation:

Ev=log₂(0.3Sv)+log₂(Bv/K)=2 log₂(Fv)+log₂(1/Tv),

where K is a constant experiential coefficient of the image field. According to the equation, the brightness value Bv can be obtained, since Sv, Fv, Tv, and K are already known. The array includes a collection of brightness values Bv associated with a collection of driving voltage values respectively. The brightness values Bv in the array are in integer form for simplifying the algorithms used for lookup in the array, and the calculated brightness value Bv is rounded to the nearest integer before retrieving a driving voltage value.

It will be understood that the above embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A display system comprising:
a display panel;
an imaging unit configured for capturing images;
an auto-focusing controller configured for determining parameters of the imaging unit suitable for the current ambient light condition by processing the captured images;
a calculating unit configured for calculating a brightness value of the current ambient light condition, using the determined parameters;
a memory unit configured for storing an array comprising a collection of brightness values associated with a collection of driving voltage values respectively; and
a regulating unit configured for retrieving a driving voltage value in an array associated with the calculated brightness value, and adjusting the display panel using the retrieved voltage value.

2. The display system as claimed in claim 1, wherein the parameters comprise exposure value Ev, aperture value Fv, exposure time Tv, and ISO speed Sv, and the parameters and the brightness values Bv satisfy an equation:
Ev=log₂(0.3Sv)+log₂(Bv/K)=2 log₂(Fv)+log₂(1/Tv),
wherein the K is a constant experiential coefficient of the image field.

3. The display system as claimed in claim 1, wherein the brightness values in the array are integers, and the calculated brightness value is rounded to the nearest integer by the regulating unit.

4. A method for auto-regulating brightness of a display system, the method comprising:
(a) capturing images via an imaging unit;
(b) determining parameters of the imaging unit that are suitable for a current ambient light condition;
(c) calculating brightness value of the current ambient light condition, based on the determined parameters; and
(d) retrieving a driving voltage value according to the calculated brightness value, and adjusting the display system using the retrieved voltage value.

5. The method as claimed in claim 4, wherein the parameters comprise exposure value Ev, aperture value Fv, exposure time Tv, and ISO speed Sv, and the parameters and the brightness values Bv satisfy an equation:
Ev=log₂(0.3Sv)+log₂(Bv/K)=2 log₂(Fv)+log₂(1/Tv),
wherein the K is a constant experiential coefficient of the image field.

6. The method as claimed in claim 4, wherein the step (d) retrieves a driving voltage value from an array which comprises a collection of brightness values associated with a collection of driving voltage values respectively.

7. The method as claimed in claim 6, wherein the brightness values in the array are integers, and the calculated brightness value is rounded to the nearest integer before retrieving a driving voltage value.
